(19) United States
(12) Patent Application Publication
(10) Pub. No.: US 2021/0375238 A1
(43) Pub. Date: Dec. 2, 2021

(54) PORTABLE ELECTRONIC DEVICES AND METHODS OF USING THE SAME

(71) Applicant: NANJING EASTHOUSE ELECTRICAL CO. LTD., NANJING (CN)

(72) Inventor: HAO MIN, NANJING (CN)

(73) Assignee: NANJING EASTHOUSE ELECTRICAL CO., LTD., NANJING (CN)

(21) Appl. No.: 16/345,717

(22) PCT Filed: Apr. 18, 2019
(86) PCT No.: PCT/CN2019/083305

§ 371 Date: Apr. 28, 2019

(51) Int. Cl. G09G 5/38; G06F 3/01; G06F 1/16

(52) U.S. Cl. CPC G09G 5/38; G06F 3/012; G06K 9/00228; G06F 1/1686; G06F 1/1694

(57) ABSTRACT

Aspects of present disclosure relates to portable electronic devices (PED). In certain embodiments, PED includes: a set of display event detection sensors for detecting display events on a display screen of PED and a display orientation control module for adjusting display orientation according to orientation of a user's face when at least one display event is detected by display event detection sensors. The display orientation control module includes a processor, and a non-volatile memory storing an operating system and a display control application having an event detection module and a display module. Display control application performs: detecting orientation of the user's face, setting orientation of the display screen of PED into a landscape view for the user according to orientation of user's face, and adjusting orientation of display screen according to orientation of the user's face, when at least one display event is detected.

### FIELD

The present disclosure generally relates to consumer electronics, and more particularly to portable electronic devices and methods of using the portable electronic devices.

### BACKGROUND

Portable electronic devices in current market usually include a rectangular display screen, and these portable electronic devices display information in two different orientations: a landscape mode as shown in FIG. 1, and a portrait mode as shown in FIG. 2. People generally prefer to view information on the display screen in landscape mode especially for displaying images and/or videos. When the display screen shows an article, it shows more characters in each line than the portrait mode. Many portable electronic devices such as smartphones, tablet computers, or electronic readers have an ability to allow user to select the display orientation by turning the display screen from one mode to another. However, most of these portable electronic devices include an accelerometer to detect the turnings and automatically adjusting the orientation of the display screen. Such automatic adjustments work well when a user is in upright position. When the user turns the display screen sideways when the user is laying down in horizontal position, such automatic adjustments will not work well, unless the user locks the display screen orientation. It is desirable to develop a display orientation control mechanism to set the default display mode into the landscape more based not on direction of gravity, but on the more natural observation of the orientation of the user's head.

Therefore, a heretofore unaddressed need still exists in the art to address the aforementioned deficiencies and inadequacies.

### SUMMARY

In one aspect, the present disclosure relates to a portable electronic device. In certain embodiments, the portable electronic device includes: a set of display event detection sensors, a display orientation control module, and a display screen. The set of display event detection sensors is used for detecting one or more display events on the display screen of the portable electronic device. The display orientation control module is used to adjust display orientation according to an orientation of a user's face when at least one display event is detected by the set of display event detection sensors. The display orientation control module includes a processor, and a non-volatile memory. The non-volatile memory stores an operating system and a display control application.

The display control application includes: an event detection module and a display module. When the display control application is executed by the processor, the display control application causes the processor to perform: detecting, by the set of display event detection sensors, an orientation of the user's face, setting, by the display module, an orientation of the display screen of the portable electronic device into a landscape view for the user according to the orientation of the user's face detected, and adjusting, by the display module, the orientation of the display screen according to the orientation of the user's face, when at least one of the set of display event detection sensors detects at least one display event.

In certain embodiments, the operation of adjusting, by the display module, the orientation of the display screen according to the orientation of the user's face includes: detecting, by the set of display event detection sensors, the orientation of the user's face, and setting, by the display module, the orientation of the display screen of the portable electronic device into the landscape view for the user according to the orientation of the user's face detected.

In certain embodiments, the portable electronic device includes: a lightweight, electrically-powered electronic device functionally capable of communications, data processing and data utility. The portable electronic device includes: a smartphone, a tablet computer, an electronic reader, a global positioning system (GPS) receiver, a medical device, a digital camera, a video camera, and a handheld computer game console.

In certain embodiments, the set of display event detection sensors includes: one or more front facing cameras, one or more magnetometers, one or more accelerometers, and one or more touch screen sensors. The front facing camera may include: an optical imaging device, a laser imaging device, and an infrared imaging device.

In certain embodiments, the display event includes: the portable electronic device is rotated in a predetermined angle, the front facing cameras of the portable electronic device is blocked in a predetermined duration of time, and the portable electronic device is turned around. In certain embodiments, the rotating and the turning of the portable electronic device are detected by: one or more front facing cameras, one or more magnetometers; and one or more accelerometers; and one or more touch screen sensors.

In certain embodiments, the operation of detecting, by the set of display event detection sensors, the orientation of the user's face includes at least one of: detecting one or more facial characters of the user's face, detecting the user's hair line, detecting the user's eye line, detecting the user's eyebrow line, detecting the user's nose profile, detecting the user's neck, detecting the user's shoulder profile, and detecting a combination of these user's features. In certain embodiments, the portable electronic device may also include an image enhancement device.

In another aspect, the present disclosure relates to a method of using a portable electronic device. In certain embodiments, the method includes: installing a display control application having an event detection module and a display module on the portable electronic device, starting the display control application, and connecting a set of display event detection sensors to the event detection module to detect one or more display events. In certain embodiments, the method also includes: detecting, by the set of display event detection sensors, an orientation of a user's face, setting, by the display module, an orientation of a display screen of the portable electronic device into a landscape view for the user according to the orientation of the user's face detected, and adjusting, by the display module, the orientation of the display screen according to the orientation of the user's face, when at least one of the set of display event detection sensors detects at least one display event.

In certain embodiments, the operation of adjusting, by the display module, the orientation of the display screen according to the orientation of the user's face includes: detecting, by the set of display event detection sensors, the orientation of the user's face, and setting, by the display module, the orientation of the display screen of the portable electronic device into the landscape view for the user according to the orientation of the user's face detected.

In certain embodiments, the portable electronic device includes: a lightweight, electrically-powered electronic device functionally capable of communications, data processing and data utility. The portable electronic device includes: a smartphone, a tablet computer, an electronic reader, a global positioning system (GPS) receiver, a medical device, a digital camera, a video camera, and a handheld computer game console.

In certain embodiments, the set of display event detection sensors includes: one or more front facing cameras, one or more magnetometers, one or more accelerometers, and one or more touch screen sensors. The front facing camera may include: an optical imaging device, a laser imaging device, and an infrared imaging device.

In certain embodiments, the display event includes: the portable electronic device is rotated in a predetermined angle, the front facing cameras of the portable electronic device is blocked in a predetermined duration of time, and the portable electronic device is turned around. In certain embodiments, the rotating and the turning of the portable electronic device are detected by: one or more front facing cameras, one or more magnetometers; and one or more accelerometers; and one or more touch screen sensors.

In certain embodiments, the operation of detecting, by the set of display event detection sensors, the orientation of the user's face includes at least one of: detecting one or more facial characters of the user's face, detecting the user's hair line, detecting the user's eye line, detecting the user's eyebrow line, detecting the user's nose profile, detecting the user's neck, detecting the user's shoulder profile, and detecting a combination of these user's features. In certain embodiments, the portable electronic device may also include an image enhancement device.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the present disclosure, and features and benefits thereof, and together with the written description, serve to explain the principles of the present invention. Wherever possible, the same reference numbers are used throughout the drawings to refer to the same or like elements of an embodiment, and wherein:

FIG. 1 shows a front view of a portable electronic device with its display screen in landscape mode according to certain embodiments of the present disclosure;

FIG. 2 shows a front view of the portable electronic device with its display screen in portrait mode according to certain embodiments of the present disclosure;

FIG. 3 shows a block diagram of the portable electronic device having ability to automatically adjust the display orientation of the display screen of the portable electronic device according to certain embodiments of the present disclosure; and

FIG. 4 shows a flow chart of a method of using the portable electronic device having ability to automatically adjust the display orientation of the display screen of the portable electronic device according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data.

Non-limiting examples of the non-transitory tangible computer readable medium are nonvolatile memory, magnetic storage, and optical storage.

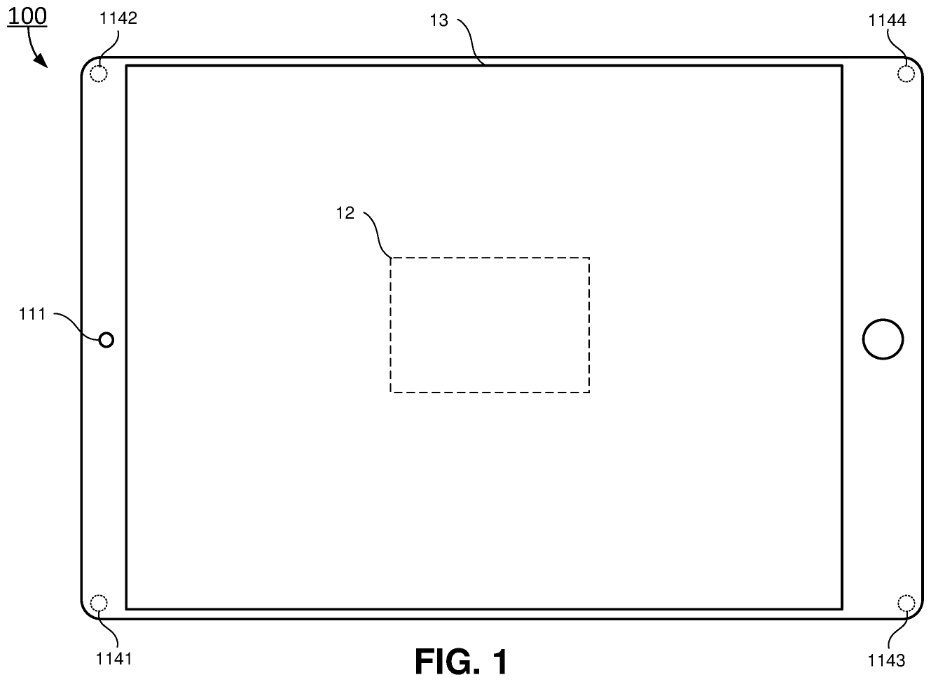

The present disclosure will now be described more fully hereinafter with reference to the accompanying drawings FIGS. 1 through 4, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

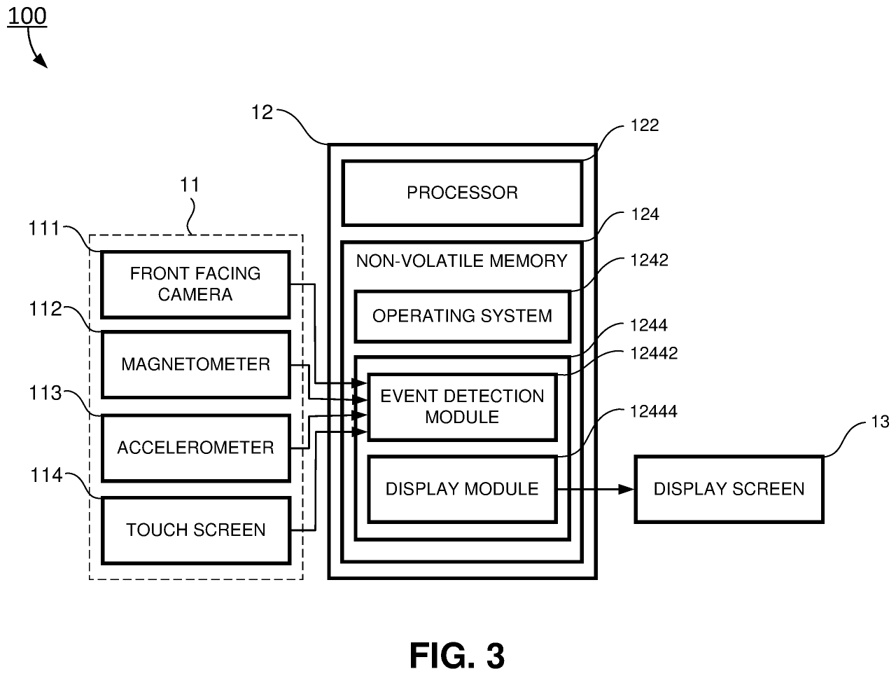

In one aspect, the present disclosure relates to a portable electronic device 100, as shown in FIG. 3. In certain embodiments, the portable electronic device 100 includes: a lightweight, electrically-powered electronic device functionally capable of communications, data processing and data utility. The portable electronic device 100 includes: smartphones such as iPhones or Android phones, tablet computers iPads or Samsung Galaxy Tabs, electronic readers such as Amazon Kindles, Fires, and Oasis, or Nook Glow light Plus, global positioning system (GPS) receivers such as Garmin, Magellan, or TomTom, certain medical devices, digital cameras and video cameras on a tablet computers, and handheld computer game consoles such as Nintendo Switch, Wii U, or Nintendo 64.

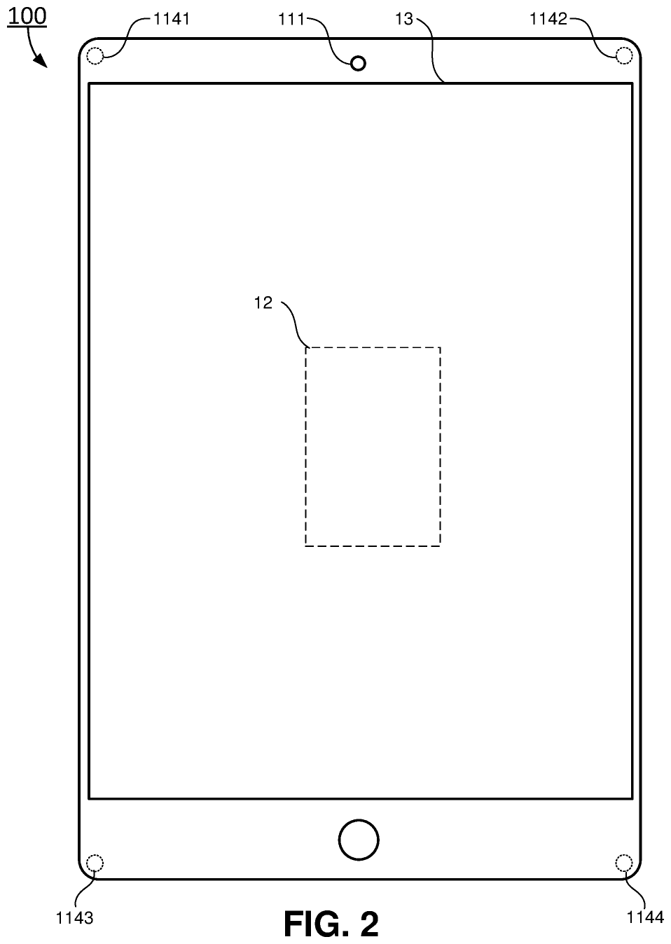

These portable electronic devices in current market usually include a rectangular display screen, and display information on its display screen in two different orientations: a landscape mode, and a portrait mode. In landscape mode, as shown in FIG. 1, the visual is wider than it is tall. On the other hand, in portrait mode, as shown in FIG. 2, the visual is taller than it is wider.

People generally prefer to view information on the display screen in landscape mode especially for displaying images and/or videos. When an article or a book is displayed on the display screen, the display screen shows more characters in each line than the portrait mode.

In certain embodiments, the portable electronic device 100 includes: a set of display event detection sensors 11, a display orientation control module 12, and a display screen 13. The set of display event detection sensors 11 is used for detecting one or more display events on the display screen 13 of the portable electronic device 100. The display orientation control module 12 is used to adjust display orientation according to an orientation of a user's face when at least one display event is detected by the set of display event detection sensors 11.

In certain embodiments, the display orientation control module 12 includes a processor 122, and a non-volatile memory 124. The non-volatile memory 124 stores an operating system 1242 and a display control application 1244. The display control application 1244 includes: an event detection module 12442 and a display module 12444. When the display control application 1244 is executed by the processor 122, the display control application 1244 causes the processor 122 to perform: detecting, by the set of display event detection sensors 11, an orientation of the user's face, setting, by the display module 12444, an orientation of the display screen 13 of the portable electronic device 100 into a landscape view for the user according to the orientation of the user's face detected, and adjusting, by the display module 12444, the orientation of the display screen 13 according to the orientation of the user's face, when at least one of the set of display event detection sensors 11 detects at least one display event.

In certain embodiments, the operation of adjusting, by the display module 12444, the orientation of the display screen 13 according to the orientation of the user's face includes: detecting, by the set of display event detection sensors 11, the orientation of the user's face, and setting, by the display module 12444, the orientation of the display screen 13 of the portable electronic device 100 into the landscape view for the user according to the orientation of the user's face detected.

In certain embodiments, the set of display event detection sensors 11 includes: one or more front facing cameras 111, one or more magnetometers 112, one or more accelerometers 113, and one or more touch screen sensors 114. The front facing camera 111 may include: an optical imaging device, a laser imaging device, and an infrared imaging device. These display event detection sensors 11 are electrically coupled to the event detection module 12442.

In certain embodiments, the display event includes: the portable electronic device 100 is rotated in a predetermined angle, the front facing cameras 111 of the portable electronic device 100 is blocked in a predetermined duration of time, and the portable electronic device 100 is turned around. In certain embodiments, the rotating and the turning of the portable electronic device 100 are detected by: one or more front facing cameras 111, one or more magnetometers 112; and one or more accelerometers 113; and one or more touch screen sensors 114.

In one embodiment, the one or more front facing cameras 111 may detect the rotating or turning of the portable electronic device 100 through images or video captured by the front facing cameras 111. In another embodiment, the one or more magnetometers 112 (not shown in FIGS. 1 and 2) are used to detect the rotating or turning of the portable electronic device 100 through its magnetic field changes. In yet another embodiment, the one or more accelerometers 113 (not shown in FIGS. 1 and 2) are used to detect the rotating or turning of the portable electronic device 100 through the motion and acceleration of the portable electronic device 100. In another embodiment, the one or more touch screen sensors 114 are used to detect the rotating or turning of the portable electronic device 100 through the four touch screen sensors 1141, 1142, 1143, and 1144 as shown in FIGS. 1 and 2.

In certain embodiments, the operation of detecting, by the set of display event detection sensors 11, the orientation of the user's face includes at least one of: detecting one or more facial characters of the user's face, detecting the user's hair line, detecting the user's eye line, detecting the user's eyebrow line, detecting the user's nose profile, detecting the user's neck, detecting the user's shoulder profile, and detecting a combination of these user's features. In certain embodiments, the portable electronic device 100 may also include an image enhancement device for enhancing images captured in certain conditions such as low lighting or bad weather.

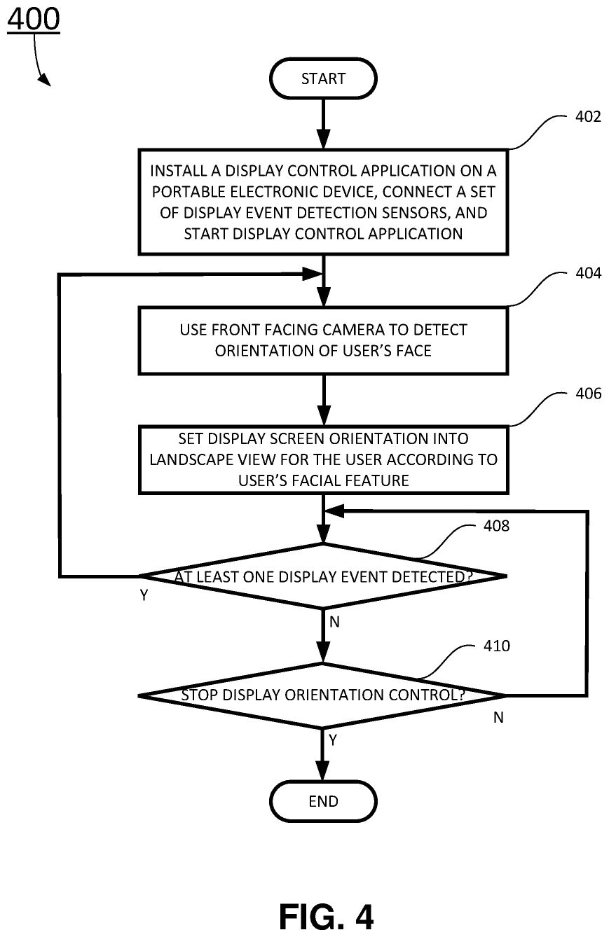

In another aspect, the present disclosure relates to a method of using a portable electronic device 100, as shown in FIG. 4. In certain embodiments, the method includes: installing a display control application 1244 having an event detection module 12442 and a display module 12444 on the portable electronic device 100, connecting a set of display event detection sensors 11 to the event detection module 12442 to detect one or more display events, and starting the display control application 1244. In certain embodiments, the method also includes: detecting, by the set of display event detection sensors 11, an orientation of a user's face, setting, by the display module 12444, an orientation of a display screen 13 of the portable electronic device 100 into a landscape view for the user according to the orientation of the user's face detected, and adjusting, by the display module 12444, the orientation of the display screen 13 according to the orientation of the user's face, when at least one of the set of display event detection sensors 11 detects at least one display event.

In certain embodiments, the operation of adjusting, by the display module 12444, the orientation of the display screen 13 according to the orientation of the user's face includes: detecting, by the set of display event detection sensors 11, the orientation of the user's face, and setting, by the display module 12444, the orientation of the display screen 13 of the portable electronic device 100 into the landscape view for the user according to the orientation of the user's face detected.

Referring to FIG. 4, the flow chart of the method 400 of using the portable electronic device 100 having ability to automatically adjust the display orientation of the display screen 13 of the portable electronic device 100 is shown according to certain embodiments of the present disclosure.

In certain embodiments, the portable electronic device 100 includes: a lightweight, electrically-powered electronic device functionally capable of communications, data processing and data utility. The portable electronic device 100 includes: a smartphone, a tablet computer, an electronic reader, a global positioning system (GPS) receiver, a medical device, a digital camera, a video camera, and a handheld computer game console.

In certain embodiments, the portable electronic device 100 includes: a set of display event detection sensors 11, a display orientation control module 12, and a display screen 13. The set of display event detection sensors 11 is used for detecting one or more display events on the display screen 13 of the portable electronic device 100. The display orientation control module 12 is used to adjust display orientation according to an orientation of a user's face when at least one display event is detected by the set of display event detection sensors 11.

At block 402, a display control application 1244 is installed on the non-volatile memory 124 of the portable electronic device 100, a set of display event detection sensors 11 is connected to the event detection module 12442 of the display control application 1244, and the display control application 1244 is started to monitor any changes of the orientation of the display screen 13, and adjust the orientation of the display screen 13 automatically when at least one display event is detected by at least one of the set of display event detection sensors 11.

In certain embodiments, the set of display event detection sensors 11 includes: one or more front facing cameras 111, one or more magnetometers 112, one or more accelerometers 113, and one or more touch screen sensors 114. The front facing camera 111 may include: an optical imaging device, a laser imaging device, and an infrared imaging device. These display event detection sensors 11 are electrically coupled to the event detection module 12442.

In certain embodiments, the display orientation control module 12 includes a processor 122, and a non-volatile memory 124. The non-volatile memory 124 stores an operating system 1242 and a display control application 1244. The display control application 1244 includes: an event detection module 12442 and a display module 12444. When the display control application 1244 is executed by the processor 122, the display control application 1244 causes the processor 122 to monitor any changes of the orientation of the display screen 13 and adjust the orientation of the display screen 13 automatically when at least one display event is detected by at least one of the set of display event detection sensors 11.

At block 404, the portable electronic device 100 uses the one or more of front facing cameras 111 to detect the orientation of the user's face.

In certain embodiments, the detection the orientation of the user's face includes at least one of: detecting one or more facial characters of the user's face, detecting the user's hair line, detecting the user's eye line, detecting the user's eyebrow line, detecting the user's nose profile, detecting the user's neck, detecting the user's shoulder profile, and detecting a combination of these user's features. In certain embodiments, the portable electronic device 100 may also include an image enhancement device for enhancing images captured in certain conditions such as low lighting or bad weather.

At block 406, the display module 12444 of the display control application 1244 sets the display screen 13 of the portable electronic device 100 into landscape view for the user according to the user's facial features detected in block 404.

In one embodiment, the display screen 13 of the portable electronic device 100 is set to be in landscape view for the user such that the longer side of the display screen 13 is approximately parallel to user's hair line, eye line, eyebrow line, or shoulder profile. In another embodiment, the display screen 13 of the portable electronic device 100 is set to be in landscape view for the user such that the shorter side of the display screen 13 is approximately parallel to the user's nose profile.

The display screen orientation is maintained until at least one display event is detected by at least one of the display event detection sensors 11.

In certain embodiments, the display event includes: the portable electronic device 100 is rotated in a predetermined angle, the front facing cameras 111 of the portable electronic device 100 is blocked in a predetermined duration of time, and the portable electronic device 100 is turned around. In certain embodiments, the rotating and the turning of the portable electronic device 100 are detected by: one or more front facing cameras 111, one or more magnetometers 112; and one or more accelerometers 113; and one or more touch screen sensors 114.

In one embodiment, the one or more front facing cameras 111 may detect the rotating or turning of the portable electronic device 100 through images or video captured by the front facing cameras 111. In another embodiment, the one or more magnetometers 112 (not shown in FIGS. 1 and 2) are used to detect the rotating or turning of the portable electronic device 100 through its magnetic field changes. In yet another embodiment, the one or more accelerometers 113 (not shown in FIGS. 1 and 2) are used to detect the rotating or turning of the portable electronic device 100 through the motion and acceleration of the portable electronic device 100. In another embodiment, the one or more touch screen sensors 114 are used to detect the rotating or turning of the portable electronic device 100 through the four touch screen sensors 1141, 1142, 1143, and 1144 as shown in FIGS. 1 and 2.

At query block 408, when at least one display event is detected by at least one of the display event detection sensors 11, the method 400 proceeds to block 404. Otherwise, the method 400 proceeds to query block 410.

At query block 410, the user decides whether the display orientation control should be stopped. When the user decides to continue, the method 400 proceeds to query block 408. Otherwise, the method 400 ends.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A portable electronic device, comprising:
a plurality of display event detection sensors for detecting one or more display events on a display screen of the portable electronic device; and
a display orientation control module for adjusting display orientation according to an orientation of a face of a user when at least one display event is detected by the plurality of display event detection sensors; wherein the display orientation control module comprises:
a processor, and a non-volatile memory storing an operating system and a display control application, wherein the display control application comprises: an event detection module and a display module, when executed by the processor, the display control application causes the processor to perform:
detecting, by the plurality of display event detection sensors, an orientation of a user's face;
setting, by the display module, an orientation of the display screen of the portable electronic device into a landscape view for the user according to the orientation of the user's face detected; and
adjusting, by the display module, the orientation of the display screen according to the orientation of the user's face, when at least one of the plurality of display event detection sensors detects at least one display event.

2. The portable electronic device according to claim 1, wherein the adjusting, by the display module, the orientation of the display screen according to the orientation of the user's face, comprises:
detecting, by the plurality of display event detection sensors, the orientation of the user's face; and
setting, by the display module, the orientation of the display screen of the portable electronic device into the landscape view for the user according to the orientation of the user's face detected.

3. The portable electronic device according to claim 1, wherein the portable electronic device comprises: a lightweight, electrically-powered electronic device functionally capable of communications, data processing and data utility.

4. The portable electronic device according to claim 3, wherein the portable electronic device comprises:
a smartphone;
a tablet computer;
an electronic reader;
a global positioning system (GPS) receiver;
a medical device;
a digital camera;
a video camera; and
a handheld computer game console.

5. The portable electronic device according to claim 1, wherein the plurality of display event detection sensors comprises:
one or more front facing cameras;
one or more magnetometers;
one or more accelerometers; and
one or more touch screen sensors.

6. The portable electronic device according to claim 5, wherein the front facing camera 111 comprises:
an optical imaging device;
a laser imaging device; and
an infrared imaging device.

7. The portable electronic device according to claim 5, wherein the display event comprises:
the portable electronic device is tilted in a predetermined angle;
the front facing cameras of the portable electronic device is blocked in a predetermined duration of time; and
the portable electronic device is turned around.

8. The portable electronic device according to claim 7, wherein the tilting and the turning of the portable electronic device are detected by: one or more front facing cameras, one or more magnetometers; and one or more accelerometers; and one or more touch screen sensors.

9. The portable electronic device according to claim 1, wherein detecting, by the plurality of display event detection sensors, the orientation of the user's face comprises:
detecting one or more facial characters of the user's face;
detecting the user's hair line;
detecting the user's eye line;
detecting the user's eyebrow line;
detecting the user's nose;
detecting the user's neck;
detecting the user's shoulder; and
detecting a combination of these user's features.

10. The portable electronic device according to claim 1, wherein the portable electronic device comprises an image enhancement device.

11. A method of using a portable electronic device, comprising:
installing a display control application on the portable electronic device, wherein the display control application comprises an event detection module and a display module and starting the display control application;
connecting a plurality of display event detection sensors to the event detection module to detect one or more display events;
detecting, by the plurality of display event detection sensors, an orientation of a user's face;
setting, by the display module, an orientation of a display screen of the portable electronic device into a landscape view for the user according to the orientation of the user's face detected; and
adjusting, by the display module, the orientation of the display screen according to the orientation of the user's face, when at least one of the plurality of display event detection sensors detects at least one display event.

12. The method according to claim 11, wherein the adjusting, by the display module, the orientation of the display screen according to the orientation of the user's face, comprises:
detecting, by the plurality of display event detection sensors, the orientation of the user's face; and
setting, by the display module, the orientation of the display screen of the portable electronic device into the landscape view for the user according to the orientation of the user's face detected.

13. The method according to claim 11, wherein the portable electronic device comprises: a lightweight, electrically-powered electronic device functionally capable of communications, data processing and data utility.

14. The method according to claim 11, wherein the portable electronic device comprises at least one of:
a smartphone;
a tablet computer;
an electronic reader;
a global positioning system (GPS) receiver;
a medical device;
a digital camera;
a video camera; and
a handheld computer game console.

15. The method according to claim 11, wherein the plurality of display event detection sensors comprises:
one or more front facing cameras;
one or more magnetometers;
one or more accelerometers; and
one or more touch screen sensors.

16. The method according to claim 15, wherein the front facing camera 111 comprises:
an optical imaging device;
a laser imaging device; and
an infrared imaging device.

17. The method according to claim 15, wherein the display event comprises:
the portable electronic device is tilted in a predetermined angle;
the front facing cameras of the portable electronic device is blocked in a predetermined duration of time; and
the portable electronic device is turned around.

18. The method according to claim 17, wherein the tilting and the turning of the portable electronic device are detected by: one or more front facing cameras, one or more magnetometers; and one or more accelerometers; and one or more touch screen sensors.

19. The method according to claim 11, wherein detecting, by the plurality of display event detection sensors, the orientation of the user's face comprises:
detecting one or more facial characters of the user's face;
detecting the user's hair line;
detecting the user's eye line;
detecting the user's eyebrow line;
detecting the user's nose;
detecting the user's neck;
detecting the user's shoulder; and
detecting a combination of these user's features.

20. The method according to claim 11, wherein the portable electronic device comprises an image enhancement device.
